(19) United States
(12) Patent Application Publication
(10) Pub. No.: US 2025/0136509 A1
(43) Pub. Date: May 1, 2025

(54) Gypsum Panel Containing an Acetate Polymer

(71) Applicant: Gold Bond Building Products, LLC, Charlotte, NC (US)

(72) Inventors: Eli Stav, Charlotte, NC (US); Ma-Ikay Miatudila, Monroe, NC (US)

(21) Appl. No.: 18/927,120

(22) Filed: Oct. 25, 2024

Related U.S. Application Data
(60) Provisional application No. 63/593,569, filed on Oct. 27, 2023.

(51) Int. Cl. C04B 24/26; B32B 13/02; B32B 13/08; B32B 37/24; C04B 24/38; C04B 28/14; C04B 103/40; C04B 111/00

(52) U.S. Cl. CPC C04B 24/2635; B32B 13/02; B32B 13/08; B32B 37/24; C04B 24/2623; C04B 24/38; C04B 28/14; B32B 2250/40; B32B 2315/00; B32B 2331/04; B32B 2607/00; C04B 2103/40; C04B 2111/0062

(57) ABSTRACT

The present disclosure is directed to a gypsum panel and a method of making such gypsum panel. For instance, the gypsum panel comprises a gypsum core and a first facing material and a second facing material sandwiching the gypsum core, wherein the gypsum core includes gypsum and an acetate polymer. The acetate polymer is present in an amount of less than 1 wt. % based on the weight of the gypsum. The gypsum panel exhibits a nail pull resistance of at least about 70 lb_{f} when tested in accordance with ASTM C1396-17. The method of the present disclosure is directed to making the aforementioned gypsum panel by providing the first facing material, providing a gypsum slurry comprising gypsum, water, and an acetate polymer onto the first facing material, wherein the acetate polymer is present in an amount of less than 1 wt. % based on the weight of the stucco, and providing a second facing material on the gypsum slurry. The gypsum panel exhibits a nail pull resistance of at least about 70 lb_{f} when tested in accordance with ASTM C1396-17.

### CROSS-REFERENCE TO RELATED APPLICATION OF THE DISCLOSURE

The present application claims filing benefit of U.S. Provisional Patent Application No. 63/593,569 having a filing date of Oct. 27, 2023, which is hereby incorporated by reference in its entirety.

### BACKGROUND OF THE DISCLOSURE

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. For instance, these conventional additives may be utilized to improve certain attributes of the gypsum panel. In particular, the additives may be utilized to improve the bond between a gypsum core and a facing material. However, such additives may not always be desired for use in gypsum panels and/or there may be a desire to use such additives in lower concentrations. Other additives may be utilized to improve the mechanical properties of the gypsum panel.

In this regard, there is a need to provide an improved gypsum panel particularly one allowing for a desired bond between the gypsum core and a facing material.

### SUMMARY OF THE DISCLOSURE

In accordance with one embodiment of the present disclosure, a gypsum panel is disclosed. The gypsum panel comprises a gypsum core and a first facing material and a second facing material sandwiching the gypsum core, wherein the gypsum core comprises gypsum and an acetate polymer. The acetate polymer is present in an amount of less than 1 wt. % based on the weight of the gypsum. The gypsum panel exhibits a nail pull resistance of at least about 70 lb_{f} when tested in accordance with ASTM C1396-17.

In accordance with another embodiment of the present disclosure, a method of making a gypsum panel is disclosed. The method comprises: providing a first facing material; depositing a gypsum slurry comprising stucco, water, and an acetate polymer onto the first facing material; providing a second facing material on the gypsum slurry; and allowing the stucco to convert to calcium sulfate dihydrate. The acetate polymer is present in an amount of less than 1 wt. % based on the weight of the stucco. The gypsum panel exhibits a nail pull resistance of at least about 70 lb_{f} when tested in accordance with ASTM C1396-17.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a gypsum panel and a method of making such gypsum panel. In particular, the gypsum panel can include a gypsum core including an acetate polymer as defined herein. In this regard, the gypsum core may include gypsum (i.e., calcium sulfate dihydrate), an acetate polymer, and may include other optional additives.

The present inventors have discovered that the gypsum panel disclosed herein can have various benefits due to the use of an acetate polymer. For instance, without intending to be limited, the present inventors have discovered that the gypsum panel may exhibit desired properties, such as desired humidified bond strength and/or nail pull strength, using an acetate polymer as disclosed herein. Furthermore, such properties may be realized while also minimizing or reducing the amount of starch within the gypsum core. Accordingly, use of the acetate polymer as disclosed herein may allow for producing a gypsum panel without sacrificing desired panel properties.

Aside from the above, the acetate polymer may also have other benefits. For instance, without intending to be limited, the acetate polymer may be able to provide other benefits to the gypsum panel manufacturing process. For instance, without intending to be limited, using of the acetate polymer as disclosed herein may allow for reduced heat during the drying process. As a result, such reduction in heat and/or drying time may also allow for an increased manufacturing line speed thereby allowing for an increase in output.

As indicated herein, a gypsum panel is disclosed. The gypsum panel comprises a gypsum core and a first facing material and a second facing material sandwiching the gypsum core. Furthermore, the gypsum core comprises gypsum and an acetate polymer.

In general, the gypsum core may comprise calcium sulfate dihydrate. The gypsum utilized in forming the gypsum slurry and resulting core may be from a natural source or a synthetic source and is thus not necessarily limited by the present disclosure. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less. In one embodiment, the aforementioned weight percentages are based on the weight of the gypsum core. In another embodiment, the aforementioned weight percentages are based on the weight of the gypsum panel. In a further embodiment, the aforementioned weight percentages are based on the weight of the solids in the gypsum slurry. The calcium sulfate dihydrate content of a gypsum panel may be determined by X-ray diffraction (XRD) analysis.

In some aspects, a gypsum panel formed in accordance with the present disclosure may have a calcium sulfate hemihydrate content of about 0.01 wt. % to about 10 wt. %, such as about 0.01 wt. % or more, such as about 0.05 wt. % or more, such as about 0.1 wt. % or more, such as about 0.2 wt. % or more, such as about 0.5 wt. % or more, such as about 0.8 wt. % or more, such as about 0.9 wt. % or more, such as about 1 wt. % or more, such as about 1.2 wt. % or more, such as about 1.5 wt. % or more, such as about 2 wt. % or more, such as about 3 wt. % or more, such as about 4 wt. % or more, such as about 5 wt. % or more. Generally, the calcium sulfate hemihydrate content of the gypsum panel is less than about 10 wt. %, such as about 8 wt. % or less, such as about 5 wt. % or less, such as about 4 wt. % or less, such as about 3 wt. % or less, such as about 2 wt. % or less, such as about 1.5 wt. % or less, such as about 1 wt. % or less, such as about 0.9 wt. % or less, such as about 0.8 wt. % or less, such as about 0.5 wt. % or less, such as about 0.2 wt. % or less, such as about 0.1 wt. % or less. In one embodiment, the aforementioned weight percentages are based on the weight of the gypsum core. In another embodiment, the aforementioned weight percentages are based on the weight of the gypsum panel. The calcium sulfate hemihydrate content of a gypsum panel may be determined by X-ray diffraction (XRD) analysis.

In addition, the gypsum core comprises an acetate polymer. It should be understood that the gypsum core disclosed herein may comprise more than one acetate polymer. For instance, the gypsum core disclosed herein may comprise two acetate polymers or three acetate polymers.

The acetate polymer may be a vinyl acetate polymer, a cellulose acetate polymer, or a mixture thereof. In one embodiment, the acetate polymer may be a cellulose acetate polymer. In another embodiment, the acetate polymer may be a vinyl acetate polymer. For instance, the vinyl acetate polymer may be a polyvinyl acetate.

The acetate polymer may be a homopolymer, a copolymer, or a mixture thereof. In one embodiment, the acetate polymer may be a homopolymer. In another embodiment, the acetate polymer may be a copolymer.

In this regard, in one embodiment, the acetate polymer may be a polyvinyl acetate homopolymer. In another embodiment, the acetate polymer may be a polyvinyl acetate copolymer (or vinyl acetate copolymer). For instance, the copolymer may be a vinyl acetate-olefin copolymer, a vinyl acetate-acrylate copolymer, or a mixture thereof. In one embodiment, the copolymer may be a vinyl acetate-olefin copolymer. In another embodiment, the copolymer may be a vinyl acetate-acrylate copolymer.

As indicated above, in one embodiment, the acetate polymer may be a vinyl acetate-olefin copolymer. The olefin may be an alpha-olefin in one embodiment. The olefin may be a C₂-C₂₀ olefin, such as a C₂-C₂₀ α-olefin. For instance, the olefin may be a C₂-C₁₀ olefin, such as a C₂-C₁₀ α-olefin. Further, the olefin may be a C₂-C₄ olefin, such as a C₂-C₄ α-olefin.

The olefin may include, but is not limited to, ethylene, propylene, a butene (e.g., 1-butene, 3-methyl-1-butene, 3,3-dimethyl-1-butene, etc.), a pentene (e.g., 1-pentene, 2-methyl-1-propene, 3-methyl-1-pentene, 4-methyl-1-pentene), a hexene (e.g., 1-hexene), a heptane (e.g., 1-heptene), an octene (e.g., 1-octene), a nonene (e.g., 1-nonene), a decene (e.g., 1-decene), a dodecene (e.g., 1-dodecene), etc. or a combination thereof.

As also indicated above, in one embodiment, the acetate polymer may be a vinyl acetate-acrylate copolymer. In general, the acrylate also includes methacrylate. In addition, the acrylate may be an alkyl ester of an acrylic acid and/or methacrylic acid. For instance, the alkyl ester may be a C₁-C₃₀ alkyl ester, such as a C₁-C₂₄ alkyl ester, such as a C₁-C₁₆ alkyl ester, such as a C₁-C₁₀ alkyl ester, such as a C₁-C₈ alkyl ester, such as a C₁-C₄ alkyl ester.

The acrylate may include, but is not limited to, methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In addition, as indicated above, the acrylates also include alkyl esters of the aforementioned monomers.

The acetate polymer may have a particular size. For instance, the acetate polymer may have a particle size distribution, measured using laser diffractometry, such that particles having a diameter of 4.5 μm or less, such as 4 μm or less, such as 3.5 μm or less provide at least 90% of the total particle volume. In one embodiment, the particle size distribution of the acetate polymer particles may be monomodal (unimodal).

While not necessarily limited, the acetate polymer may have a weight average molecular weight of 1,000 g/mol or more, such as 5,000 g/mol or more, such as 10,000 g/mol or more, such as 25,000 g/mol or more, such as 35,000 g/mol or more, such as 40,000 g/mol or more, such as 45,000 g/mol or more, such as 50,000 g/mol or more. The acetate polymer may have a molecular weight of 1,000,000 g/mol or less, such as 750,000 g/mol or less, such as 500,000 g/mol or less, such as 250,000 g/mol or less, such as 200,000 g/mol or less, such as 150,000 g/mol or less, such as 100,000 g/mol or less, such as 80,000 g/mol or less, such as 70,000 g/mol or less, such as 60,000 g/mol or less, such as 55,000 g/mol or less, such as 50,000 g/mol or less, such as 40,000 g/mol or less, such as 30,000 g/mol or less, such as 20,000 g/mol or less, such as 10,000 g/mol or less. The molecular weight may be determined using means in the art, such as gel permeation chromatography.

Generally, the acetate polymer may be present in the gypsum core in a particular amount. For instance, the acetate polymer may be present in an amount of 0.0001 wt. % or more, such as 0.001 wt. % or more, such as 0.005 wt. % or more, such as 0.01 wt. % or more, such as 0.02 wt. % or more, such as 0.03 wt. % or more, such as 0.05 wt. % or more, such as 0.07 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the acetate polymer may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.09 wt. % or less, such as 0.08 wt. % or less, such as 0.07 wt. % or less, such as 0.06 wt. % or less, such as 0.05 wt. % or less, such as 0.04 wt. % or less, such as 0.03 wt. % or less, such as 0.02 wt. % or less, such as 0.01 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

The acetate polymer may be present in the gypsum panel in an amount of 0.0001 lbs/MSF to 50 lbs/MSF, including all increments of 0.0001 lbs/MSF therebetween. For instance, the acetate polymer may be present in the gypsum panel in an amount of 0.0001 lbs/MSF or more, such as 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more. Generally, the acetate polymer may be present in the gypsum panel in an amount of 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

As indicated herein, the acetate polymer may allow for a reduction in the amount of starch utilized. In one embodiment, the amount of starch utilized in the gypsum core (or gypsum slurry) and resulting gypsum panel may be more than the amount of acetate polymer utilized in the gypsum core (or gypsum slurry) and resulting gypsum panel. In another embodiment, the amount of starch utilized in the gypsum core (or gypsum slurry) and resulting gypsum panel may be the same as the amount of acetate polymer utilized in the gypsum core (or gypsum slurry) and resulting gypsum panel. In a further embodiment, the amount of starch utilized in the gypsum core (or gypsum slurry) and resulting gypsum panel may be less than the amount of acetate polymer utilized in the gypsum core (or gypsum slurry) and resulting gypsum panel.

Furthermore, the acetate polymer may be provided within the gypsum panel, particularly the gypsum core and the gypsum slurry as defined herein, within a liquid. For instance, the liquid may include water. For instance, the liquid may include 50 wt. % or more, such as 60 wt. % or more, such as 70 wt. % or more, such as 80 wt. % or more, such as 90 wt. % or more, such as 95 wt. % or more, such as 98 wt. % or more of water based on the total weight of the liquid. In this regard, the acetate polymer may be provided to the gypsum slurry for forming the gypsum core and the gypsum panel as an emulsion. In this regard, the acetate polymer, and/or acetate polymer emulsion, may be surfactant stabilized. Accordingly, the gypsum core and resulting gypsum panel may also include the surfactant as mentioned herein.

The surfactant is not necessarily limited and may be one utilized in stabilizing the acetate polymer. For instance, the surfactant may include a cationic surfactant, an anionic surfactant, a nonionic surfactant, or a mixture thereof. In one embodiment, the surfactant includes a cationic surfactant. In another embodiment, the surfactant includes an anionic surfactant. In a further embodiment, the surfactant includes a nonionic surfactant. The surfactant may be one that is commonly utilized in emulsion polymerization.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. In one embodiment, the anionic surfactant may include sodium lauryl sulfate. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the non-ionic surfactant may be an alkylphenol ethoxylate, such as a nonylphenol ethoxylate.

In one embodiment, the surfactant may include a cationic surfactant. For instance, the surfactant may include a cationic surfactant such as water-soluble quaternary ammonium compounds, polyammonium salts, a polyoxyethylene alkylamine and the like as well as mixtures thereof. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In general, the surfactant(s) may be present in the core in an amount of 0 wt. % or more, such as 0.0001 wt. % or more, such as 0.0005 wt. % or more, such as 0.001 wt. % or more, such as 0.005 wt. % or more, such as 0.01 wt. % or more, such as 0.05 wt. % or more, such as 0.1 wt. % or more based on the weight of the core. The surfactant(s) may be present in the core in an amount of 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.15 wt. % or less, such as 0.1 wt. % or less, such as 0.08 wt. % or less, such as 0.05 wt. % or less, such as 0.03 wt. % or less, such as 0.01 wt. % or less, such as 0.005 wt. % or less, such as 0.001 wt. % or less based on the weight of the core. In one embodiment, a surfactant may not be utilized such that the weight percentage is 0. In addition, it should be understood that the aforementioned weight percentages may also apply to the amount of the surfactant(s) based on the weight of the gypsum panel. Further, it should be understood that the aforementioned weight percentages may also apply to the amount of the surfactant(s) based on the weight of the gypsum slurry.

In one embodiment, the acetate polymer may be provided with an alcohol polymer. For instance, when the acetate polymer comprises a vinyl acetate polymer, such as a polyvinyl acetate homopolymer and/or a polyvinyl acetate copolymer, the alcohol polymer may be polyvinyl alcohol. In this regard, the gypsum core may include both the acetate polymer, such as polyvinyl acetate, and the alcohol polymer, such as polyvinyl alcohol.

In this regard, the alcohol polymer, such as polyvinyl alcohol, may be provided in the gypsum core in a particular amount. For instance, the alcohol polymer, such as polyvinyl alcohol, may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the alcohol polymer, such as polyvinyl alcohol, may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less, such as 0.01 wt. % or less, such as 0.001 wt. % or less. In one embodiment, the gypsum core may not include an alcohol polymer, such as a polyvinyl alcohol. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In general, the composition of the gypsum core is not necessarily limited and may include any additives as known in the art. For instance, the additives may include dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, graphite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches (such as pregelatinized starch, non-pregelatinized starch, and/or an acid modified starch), sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present disclosure.

Each additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one embodiment, the gypsum core may include expanded materials and/or unexpanded materials within a certain amount. For instance, these may include expanded vermiculite, expanded perlite, expanded graphite, or a mixture thereof. The unexpanded materials may include unexpanded vermiculite, unexpanded perlite, unexpanded graphite, or a mixture thereof. In addition, it should be understood that any of the aforementioned expanded materials and/or unexpanded materials may be utilized in combination. Each respective additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one particular embodiment, the gypsum core may include the aforementioned expanded perlite in such an amount. For instance, such expanded perlite may be present in a reduced amount, such as an amount of less than 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of expanded perlite. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one particular embodiment, the gypsum core may include a monobasic phosphate in a particular amount. These monobasic phosphates may include, but are not limited to, monoammonium phosphate, monopotassium phosphate, monosodium phosphate, monolithium phosphate, and combinations thereof. Such monobasic phosphate may be present in a reduced amount, such as an amount of less than 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of monobasic phosphate. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one particular embodiment, the gypsum core may include a particulate material in a particular amount. These particulate materials may have a porosity at least equal to 5% and pores having a diameter varying between 0.001 and 100 nanometers. Such particulate material may be present in a reduced amount, such as an amount of less than 5 wt. %, such as 4.5 wt. % or less, such as 4 wt. % or less, such as 3.5 wt. % or less, such as 3 wt. % or less, such as 2.5 wt. % or less, such as 2 wt. % or less, such as 1.5 wt. % or less, such as 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of the aforementioned particulate material. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one particular embodiment, the gypsum core may include glass fibers in a particular amount. Such glass fibers may be present in a reduced amount, such as an amount of 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of the glass fibers. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

Furthermore, to the extent glass fibers are present, they may be present in a particular ratio compared to the synthetic polymer binders, such as the acetate polymer, present within the gypsum core and/or gypsum slurry. For instance, the weight ratio of the synthetic polymer binders, such as the acetate polymer, to the glass fibers may be less than 2, such as 1.8 or less, such as 1.6 or less, such as 1.4 or less, such as 1.2 or less, such as 1.0 or less, such as 0.8 or less, such as 0.6 or less, such as 0.4 or less, such as 0.2 or less, such as 0.1 or less, such as 0.05 or less.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present disclosure is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes an acetate polymer. In this regard, the method may include a step of also combining an acetate polymer with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present disclosure. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

Furthermore, as indicated above, the gypsum slurry may also include an acetate polymer as defined herein. In addition, as also indicated above, the acetate polymer may be provided within a liquid. For instance, the liquid may include water. For instance, the liquid may include 50 wt. % or more, such as 60 wt. % or more, such as 70 wt. % or more, such as 80 wt. % or more, such as 90 wt. % or more, such as 95 wt. % or more, such as 98 wt. % or more of water based on the total weight of the liquid. In this regard, the acetate polymer may be provided for forming the gypsum slurry as an emulsion. In this regard, the acetate polymer, and/or acetate polymer emulsion, may be surfactant stabilized. Accordingly, the gypsum slurry may also include the surfactant as mentioned herein. In addition, the surfactant may be one as mentioned above with respect to the stabilization of the acetate polymer. In particular, the surfactant may be one that is commonly utilized in emulsion polymerization.

As indicated above, the gypsum slurry may also include water. Water may be employed for fluidity and also for rehydration of the gypsum to allow for setting. The amount of water utilized is not necessarily limited by the present disclosure.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to stucco, water, and the acetate polymer, the gypsum slurry may also include any other conventional additives as known in the art. In this regard, such additives are not necessarily limited by the present disclosure. For instance, the additives may include dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, graphite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present disclosure.

Each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one embodiment, the gypsum slurry may include expanded materials within a certain amount. For instance, these may include expanded vermiculite, expanded perlite, expanded graphite, or a mixture thereof. Each respective additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one particular embodiment, the gypsum slurry may include the aforementioned expanded perlite in such an amount. For instance, such expanded perlite may be present in a reduced amount, such as an amount of less than 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum slurry may not include any and thus may be free of expanded perlite. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one particular embodiment, the gypsum slurry may include a monobasic phosphate in a particular amount. These monobasic phosphates may include, but are not limited to, monoammonium phosphate, monopotassium phosphate, monosodium phosphate, monolithium phosphate, and combinations thereof. Such monobasic phosphate may be present in a reduced amount, such as an amount of less than 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum slurry may not include any and thus may be free of monobasic phosphate. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one particular embodiment, the gypsum slurry may include a particulate material in a particular amount. These particulate materials may have a porosity at least equal to 5% and pores having a diameter varying between 0.001 and 100 nanometers. Such particulate material may be present in a reduced amount, such as an amount of less than 5 wt. %, such as 4.5 wt. % or less, such as 4 wt. % or less, such as 3.5 wt. % or less, such as 3 wt. % or less, such as 2.5 wt. % or less, such as 2 wt. % or less, such as 1.5 wt. % or less, such as 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum slurry may not include any and thus may be free of the aforementioned particulate material. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one particular embodiment, the gypsum slurry may include glass fibers in a particular amount. Such glass fibers may be present in a reduced amount, such as an amount of 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum slurry may not include any and thus may be free of the glass fibers. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

The foaming agent may be one generally utilized in the art. Such foaming agent may be combined with the stucco, water, and the acetate polymer. In this regard, such foaming agent may be present in the gypsum slurry as well as the resulting gypsum core and gypsum panel.

The foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate.

The alkyl sulfate may have a general formula as follows:

H(CH₂)ₙOSO₃⁻M+

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

CH₃(CH₂)ₓCH₂—(OCH₂CH₂)—OSO₃⁻M⁺

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

When a mixture of an alkyl sulfate and an alkyl ether sulfate is present, the alkyl ether sulfate may be present in an amount of from more than 0 wt. % to less than 100 wt. %. For instance, in the mixture, the alkyl ether sulfate may be present in an amount of more than 0 wt. %, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In the mixture, the alkyl ether sulfate may be present in an amount of less than 100 wt. %, such as 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less. Such weight percentage may be based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 0.001 or more, such as 0.005 or more, such as 0.01 or more, such as 0.05 or more, such as 0.1 or more, such as 0.2 or more, such as 0.3 or more, such as 0.5 or more, such as 1 or more, such as 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less, such as 3 or less, such as 2 or less, such as 1 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties.

In one aspect, the foam may be provided in an amount of 1 lb/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 50 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less, such as 80 lbs/MSF or less, such as 60 lbs/MSF or less, such as 50 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof. In another embodiment, the dispersant may include a carboxylate, such as a carboxylate ether and in particular a polycarboxylate ether or a carboxylate ester and in particular a polycarboxylate ester. In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco, water, and the acetate polymer. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

In one embodiment, when present, the pearl starch may be in the gypsum core in a particular amount. The pearl starch may be present in a reduced amount, such as an amount of less than 3 wt. % or less, such as 2.5 wt. % or less, such as 2 wt. % or less, such as 1.5 wt. % or less, such as 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of pearl starch. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present disclosure.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

Generally, the starch may be present in the gypsum core in a particular amount. For instance, the starch may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the starch may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

The manner in which the components (e.g., stucco, water, acetate polymer) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Furthermore, regarding the acetate polymer, it may be provided as a solid. Alternatively, it may be dissolved in water initially. In particular, the water utilized for providing the acetate polymer may be the same water as that utilized to provide the foaming agent. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present disclosure.

In one embodiment, the gypsum core may include a first gypsum core layer and a second gypsum core layer. The first gypsum core layer may be between the first facing material (i.e., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as an acetate polymer. Further, the first gypsum core layer, the second gypsum core layer, and/or the third gypsum core layer may contain an additive in an amount as previously indicated herein.

As indicated herein, the gypsum core can include an acetate polymer. In this regard, in one embodiment, the first gypsum core layer may include an acetate polymer as disclosed herein. In another embodiment, the second gypsum core layer may include an acetate polymer as disclosed herein. In a further embodiment, the third gypsum core layer may include an acetate polymer as disclosed herein. In an even further embodiment, the first gypsum core layer and the second gypsum core layer may include an acetate polymer as disclosed herein. In another further embodiment, the first gypsum core layer, the second gypsum core layer, and the third gypsum core layer may include an acetate polymer as disclosed herein. In yet another embodiment, an acetate polymer may be included adjacent to the first facing material and/or the second facing material.

Regardless of the above, an acetate polymer may be present in any combination of gypsum core layers. However, in one embodiment, it should be understood that one or two of the aforementioned gypsum core layers may not include an acetate polymer. In one aspect, one or more gypsum core layers may comprise the same acetate polymer. Further, in one aspect, the one or more gypsum core layers may comprise different acetate polymers. The different acetate polymers of the one or more gypsum core layers may be chosen such that it is advantageous to have a particular acetate polymer in one gypsum core layer and a different acetate polymer in another, different gypsum core layer.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 10 pcf or more, such as about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. The facing material may cover more than 0%, such as 5% or more, such as 10% or more, such as 20% or more, such as 30% or more, such as 40% or more, such as 50% or more, such as 60% or more, such as 70% or more, such as 80% or more, such as 85% or more, such as 90% or more, such as 93% or more, such as 95% or more, such as 98% or more, such as 99% or more of the surface area of the gypsum core. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels. In one embodiment, the aforementioned test may be performed upon conditioning for 20 hours in a humidity chamber at 90° F. and 90% humidity.

Also, stated in other words, the aforementioned humidified bond may have a percentage failure, which would indicate the inverse of the above percent coverage. For instance, the percentage failure would be indicative of the amount of facing material removed thereby exposing a certain area or percentage of the gypsum core. In this regard, after exposure, the percent failure may be 0% or more, such as 1% or more, such as 2% or more, such as 3% or more, such as 4% or more, such as 5% or more, such as 8% or more, such as 10% or more, such as 15% or more, such as 20% or more, such as 25% or more, such as 30% or more, such as 35% or more, such as 40% or more, such as 50% or more. The percentage failure may be less than 100%, such as 90% or less, such as 80% or less, such as 70% or less, such as 60% or less, such as 50% or less, such as 40% or less, such as 30% or less, such as 25% or less, such as 20% or less, such as 15% or less, such as 12% or less, such as 10% or less, such as 8% or less, such as 6% or less, such as 4% or less, such as 3% or less, such as 2% or less, such as 1% or less. Similarly, such percent failure may be determined using various optical analytical techniques. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

In addition to the above, the gypsum panel may exhibit desired acoustical properties. For instance, the noise reduction coefficient (“NRC”) is generally a measure of the sound absorption property of a gypsum panel. Generally, an NRC value may range from 0 to 1.00. As an example, an NRC value of 0.70 means that approximately 70% of the sound is absorbed by a panel, while approximately 30% is reflected back into the environment. In this regard, gypsum panels made according to the present invention may have a certain NRC value compared to other types of gypsum panels. For instance, the NRC value of the gypsum panel disclosed herein may be 0.05 or more, such as 0.10 or more, such as 0.15 or more, such as 0.20 or more, such as 0.21 or more, such as 0.23 or more, such as 0.25 or more, such as 0.27 or more, such as 0.29 or more, such as 0.30 or more, such as 0.31 or more, such as 0.32 or more, such as 0.33 or more, such as 0.34 or more, such as 0.35 or more, such as 0.36 or more, such as 0.37 or more, such as 0.38 or more, such as 0.39 or more, such as 0.40 or more, such as 0.41 or more, such as 0.42 or more, such as 0.43 or more, such as 0.44 or more, such as 0.45 or more, such as 0.46 or more, such as 0.47 or more, such as 0.48 or more, such as 0.49 or more, such as 0.50 or more. The NRC value of the gypsum panel may be 1.00 or less, such as 0.90 or less, such as 0.80 or less, such as 0.70 or less, such as 0.60 or less, such as 0.55 or less, such as 0.53 or less, such as 0.50 or less, such as 0.48 or less, such as 0.46 or less, such as 0.45 or less, such as 0.43 or less, 0.41 or less, such as 0.40 or less, such as 0.35 or less, such as 0.32 or less, such as 0.30 or less, such as 0.28 or less, such as 0.25 or less, such as 0.23 or less, such as 0.20 or less. In one embodiment, the aforementioned NRC values are based on ASTM C423-22, herein incorporated by reference in its entirety. In another embodiment, the aforementioned NRC values are based on ASTM E1050-19, herein incorporated by reference in its entirety. For example, such latter test may be employed for small-scale testing.

### EXAMPLES

### Example 1

Gypsum panels were made with an acetate polymer, in particular a polyvinyl acetate (PVAc) homopolymer. In addition, certain samples included starch. The gypsum panels had a thickness of ⅝″. The gypsum panels were analyzed to determine the panel weight and the effect of the acetate polymer on the panel properties.

| | | | | | 2 Hrs Humidified | | 20 Hrs Humidified | |
|---|---|---|---|---|---|---|---|---|
| | Panel Wt. | Nail-Pull | Std | Nail-Pull/ | Bond (% Failure) | | Bond (% Failure) | |
| Description | (lbs/MSF) | (lb_{f}) | Dev | Panel Wt. | Face | Back | Face | Back |
| 12 lbs starch | 2293 | 103 | 8 | 0.045 | 16% | 3% | 0% | 2% |
| (control) | | | | | | | | |
| 9 lbs starch | 2280 | 94 | 7 | 0.041 | 37% | 4% | 2% | 3% |
| (control) | | | | | | | | |
| 9 lbs starch + | 2367 | 108 | 6 | 0.046 | 10% | 1% | 12% | 4% |
| 0.5 lbs PVAc | | | | | | | | |
| 6 lbs starch + | 2287 | 96 | 9 | 0.042 | 15% | 5% | 25% | 4% |
| 0.5 lbs PVAc | | | | | | | | |

By utilizing polyvinyl acetate and a reduced amount of starch, the kiln heat was reduced by a total of 97° F. In addition, when utilizing polyvinyl acetate with a reduction in the amount of starch, the nail-pull strength and the 2-hour humidified bond properties were maintained compared to panels without the polyvinyl acetate. In particular, when utilizing 9 lbs. of starch with polyvinyl acetate, an increase in nail-pull strength was observed.

### Example 2

Gypsum panels were made with an acetate polymer, in particular a polyvinyl acetate homopolymer. In addition, certain samples included starch. The gypsum panels had a thickness of ⅝″. The gypsum panels were analyzed to determine the panel weight and the effect of the acetate polymer on the panel properties.

| | | | | Nail-Pull/ | | Kiln |
|---|---|---|---|---|---|---|
| | Panel Wt. | Nail-Pull | Std | Panel | Delayed | Temperature |
| Description | (lbs/MSF) | (lb_{f}) | Dev | Wt. | Peel | Reduction (° F.) |
| 9 lbs starch | 2279 | 107 | 8 | 0.047 | No delayed | |
| (control) | | | | | peel | |
| 8 lbs starch | 2275 | 114 | 11 | 0.050 | No delayed | Reduced heat |
| (control) | | | | | peel | by 10° F. total |
| 6 lbs starch | 2287 | 114 | 7 | 0.050 | Delayed peel | Reduced heat |
| (control) | | | | | | by 20° F. total |
| 6 lbs starch + | 2298 | 112 | 8 | 0.049 | No delayed | No heat |
| 0.5 lbs PVAc | | | | | peel | changed from |
| | | | | | | control at 6 lbs |
| | | | | | | starch |

By utilizing polyvinyl acetate and a reduced amount of starch, the kiln heat was reduced by a total of 30° F. In addition, when utilizing polyvinyl acetate with a reduction in the amount of starch, the nail-pull strength was maintained compared to panels without the polyvinyl acetate.

In addition, the panel including polyvinyl acetate exhibited no delayed peel. In general, delayed peel refers to peeling of the facing material from the gypsum core after the panel is held at room temperature for 24 hours.

### Example 3

Gypsum panels were made with an acetate polymer, in particular a polyvinyl acetate homopolymer. In addition, certain samples included starch. The gypsum panels had a thickness of ½″. The gypsum panels were analyzed to determine the panel weight and the effect of the acetate polymer on the panel properties.

| | | | | | 2 Hrs Humidified | | 20 Hrs Humidified | |
|---|---|---|---|---|---|---|---|---|
| | Panel Wt. | Nail-Pull | Std | Nail-Pull/ | Bond (% Failure) | | Bond (% Failure) | |
| Description | (lbs/MSF) | (lb_{f}) | Dev | Panel Wt. | Face | Back | Face | Back |
| 22 lbs starch | 1257 | 75 | 5 | 0.060 | 0% | 0% | 1% | 2% |
| (control) | | | | | | | | |
| 17 lbs starch + | 1250 | 71 | 4 | 0.057 | 0% | 0% | 1% | 2% |
| 0.5 lbs PVAc | | | | | | | | |

By utilizing polyvinyl acetate and a reduced amount of starch, the nail-pull strength and the humidified bond properties were maintained compared to panels without the polyvinyl acetate.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising a gypsum core and a first facing material and a second facing material sandwiching the gypsum core, wherein the gypsum core comprises gypsum and an acetate polymer and wherein the acetate polymer is present in an amount of less than 1 wt. % based on the weight of the gypsum,
wherein the gypsum panel exhibits a nail pull resistance of at least about 70 lb_{f} when tested in accordance with ASTM C1396-17.

2. The gypsum panel of claim 1, wherein the gypsum is present in an amount of at least 60 wt. % based on the weight of the gypsum core.

3. The gypsum panel of claim 1, wherein the acetate polymer comprises a vinyl acetate polymer, a cellulose acetate polymer, or a mixture thereof.

4. The gypsum panel of claim 1, wherein the acetate polymer includes a vinyl acetate polymer.

5. The gypsum panel of claim 1, wherein the vinyl acetate polymer includes a polyvinyl acetate homopolymer.

6. The gypsum panel of claim 1, wherein the gypsum core comprises polyvinyl alcohol in an amount of from 0 wt. % to less than 0.5 wt. % based on the weight of the gypsum core.

7. The gypsum panel of claim 1, wherein the gypsum core comprises polyvinyl alcohol in an amount of from 0 wt. % to less than 0.2 wt. % based on the weight of the gypsum core.

8. The gypsum panel of claim 1, wherein the gypsum core is free of polyvinyl alcohol.

9. The gypsum panel of claim 1, wherein the acetate polymer is present in an amount of less than 0.8 wt. % based on the weight of the gypsum.

10. The gypsum panel of claim 1, wherein the acetate polymer is present in an amount from about 0.001 wt. % to about 0.1 wt. % based on the weight of the gypsum.

11. The gypsum panel of claim 1, wherein the gypsum core further comprises a surfactant utilized for stabilizing the acetate polymer.

12. The gypsum panel of claim 1, wherein the gypsum core further comprises a starch.

13. The gypsum panel of claim 12, wherein the starch comprises a pearl starch.

14. The gypsum panel of claim 12, wherein the starch comprises an acid-modified starch.

15. The gypsum panel of claim 12, wherein the starch comprises a pregelatinized starch.

16. The gypsum panel of claim 12, wherein the starch is present in the gypsum core in an amount greater than the acetate polymer.

17. The gypsum panel of claim 1, wherein the gypsum core comprises expanded perlite in an amount of from 0 wt. % to less than 0.5 wt. % based on the weight of the gypsum core.

18. The gypsum panel of claim 1, wherein the gypsum panel exhibits a nail pull resistance of at least about 77 lb_{f} when tested in accordance with ASTM C1396-17.

19. The gypsum panel of claim 1, wherein the gypsum panel exhibits a nail pull resistance of at least about 90 lb_{f} when tested in accordance with ASTM C1396-17.

20. The gypsum panel of claim 1, wherein the gypsum panel has an NRC value of less than 0.32 when tested in accordance with ASTM E1050-19.

21. The gypsum panel of claim 1, wherein the gypsum panel has an NRC value of less than 0.25 when tested in accordance with ASTM E1050-19.

22. A method for making a gypsum panel, the method comprising:
providing a first facing material;
depositing a gypsum slurry comprising stucco, water, and an acetate polymer onto the first facing material, wherein the acetate polymer is present in an amount of less than 1 wt. % based on the weight of the stucco;
providing a second facing material on the gypsum slurry; and
allowing the stucco to convert to calcium sulfate dihydrate;
wherein the gypsum panel exhibits a nail pull resistance of at least about 70 lb_{f} when tested in accordance with ASTM C1396-17.
